(19) United States
(12) Patent Application Publication
(10) Pub. No.: US 2009/0167515 A1
(43) Pub. Date: Jul. 2, 2009

(54) AUTOMATED TELLTALE IDENTIFICATION

(75) Inventors: Theodore Scherzinger, Sammamish, WA (US); Christopher Harry, Bellevue, WA (US); Tyson Green, Duvall, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: PACCAR INC, Bellevue, WA (US)

(21) Appl. No.: 11/966,793

(22) Filed: Dec. 28, 2007

(51) Int. Cl. B60Q 1/00; G08B 1/08

(52) U.S. Cl. 340/438; 340/539.1

(57) ABSTRACT

A vehicle display device includes a display panel having a light emitting device. The display device further includes a display panel cover coupled to the display panel. The display panel cover has a translucent indicium that corresponds to the light emitting device. A signal transmitting device is provided on the display panel cover for sending a signal corresponding to the indicium on the display panel cover. The display device also has a signal receiving device capable of receiving a signal transmitted by the signal transmitting device and sending the signal to a control module. The control module is adapted to selectively operate the light emitting device according to the signal transmitted by the signal transmitting device.

### BACKGROUND

Most vehicles include instrument clusters to provide visual indicators that inform a vehicle operator of various operating conditions. A typical known instrument cluster, such as the one shown in FIG. 1, can include gauges for indicating fuel level, oil pressure, engine temperature, vehicle speed, engine speed, etc.

In addition to standard dials and gauges, many instrument clusters also include a telltale warning light system. The telltale warning light system comprises one or more icons (telltales), which are selectively illuminated to indicate a particular operating condition. When a telltale is not illuminated, it is generally not visible to the vehicle operator and appears as a blank area on the vehicle cluster. When a telltale is illuminated, it is visible to the vehicle operator and relays information through visual means, such as a text message or an icon. For example, as shown in FIG. 1, the letter “P” may be illuminated to indicate to the vehicle operator that the parking brake is engaged. Other typical telltales include turn signal indicators, high beam indicators, engine overheating warnings, and “check engine” lights. In addition to switching between an illuminated state and an unilluminated state, a particular telltale may be selectively illuminated with different colors in order to provide different states of a given system with a single telltale. For example, a telltale for displaying information about engine temperature may be illuminated as green under normal operating conditions, yellow as the engine temperature approaches a predetermined threshold, and red if the engine temperature exceeds the threshold. Because telltales are present in a wide variety of vehicle types, including automobiles, heavy duty trucks, motorcycles, ATV's, boats, aircraft, etc., telltale configurations can vary greatly, depending on the type of information that would be relevant to the operator of a particular vehicle.

For a typical instrument cluster, a telltale comprises one or more light sources disposed behind a generally opaque display cover. A translucent telltale icon is formed in the display cover proximate to the one or more light sources. When the one or more light sources emit light, a portion of the emitted light passes through the icon, providing an illuminated image in the shape of the icon. When the one or more light sources are not emitting light, the icon, and thus the telltale, are generally inconspicuous to the vehicle operator.

Telltale warning light systems further include a control module to control the illumination of the telltales. Sensors located on the vehicle detect predetermined parameters and send signals to the control module. The control module is programmed to determine the presence of certain operating conditions based on the signals received from the sensors. When the control module determines the presence of a predetermined vehicle condition, the control module communicates with the display panel to selectively control illumination of the associated telltale.

The control module can be programmed to accommodate various telltale configurations. Thus, the telltale configuration of an instrument cluster can be configured by selecting a display cover with the desired telltale icons and programming the control unit to illuminate the telltales in response to the appropriate operating conditions. Similarly, an existing instrument cluster can be reconfigured by replacing the existing display cover with a display cover having different telltales and reprogramming the control module to operate according to the requirements of the new telltales.

### SUMMARY

A system and a method of automatic telltale identification are disclosed. In one embodiment, a vehicle display device includes a display panel and a display panel cover attached thereto. The display panel includes a selectively operable light emitting device, and the display panel cover includes a translucent indicium that corresponds to the light emitting device. When the vehicle display cover is attached to the vehicle display, the light emitting device is located behind the translucent indicium so that when the light emitting device emits light, an illuminated image in the shape of the indicium, i.e., a telltale, is visible on the display panel cover. The telltales are illuminated in response to detected operating conditions in order to make the vehicle operator aware of the detected conditions.

A signal transmitting device is provided on the display panel cover for transmitting a signal corresponding to the translucent indium included on the display panel cover. A signal receiving device is adapted to receive the signal from the signal transmitting device and send the signal to a control module. The control module selectively operates the light emitting device according to the signal.

A method of programming a microprocessor that controls telltales on a vehicle display device is disclosed. The method includes transmitting a signal from a transmitter that is provided on a display panel cover to be attached to the vehicle display device. The method further includes receiving the transmitted signal with a receiver, sending the received signal to the microprocessor, and programming the microprocessor to selectively operate a light emitting device on the display device according to the signal received by the receiver.

A method of installing a display cover for a vehicle display having telltales is also disclosed, wherein the display cover has a translucent indicium corresponding to a selectively operable light emitting device located on a vehicle display. The display cover further includes a transmitter adapted to transmit a signal to identify the translucent indicium on the display cover. The method includes providing the display cover and attaching the display cover to the vehicle display so that the light emitting device selectively emits light to illuminate the indium. A receiver is adapted to receive a signal transmitted from the transmitter and send the signal to the a control module. The control module is adapted to selectively operate the light emitting device according to the signal transmitted from the transmitter and received by the receiver.

A display panel cover for a vehicle display device is disclosed, wherein the vehicle display device has a selectively operable light emitting device and a signal receiving device. The display panel cover includes at least one translucent indicium corresponding to the selectively operable light emitting device. The display panel further includes a signal transmitting device for sending a signal to the signal receiving device. The signal corresponds to the at least one indicium included on the display panel cover.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an isometric view of a known instrument cluster installed in a vehicle dashboard;

FIG. 2 is an isometric view of an instrument cluster having one embodiment of the presently disclosed automated telltale identification system;

FIG. 3 is a front view of an icon card shown in FIG. 2; and

FIG. 4 is a schematic diagram of one embodiment of the presently disclosed automated telltale identification system.

### DETAILED DESCRIPTION

While illustrative embodiments have been illustrated and described, it will be appreciated that various changes can be made therein without departing from the spirit and scope of the invention.

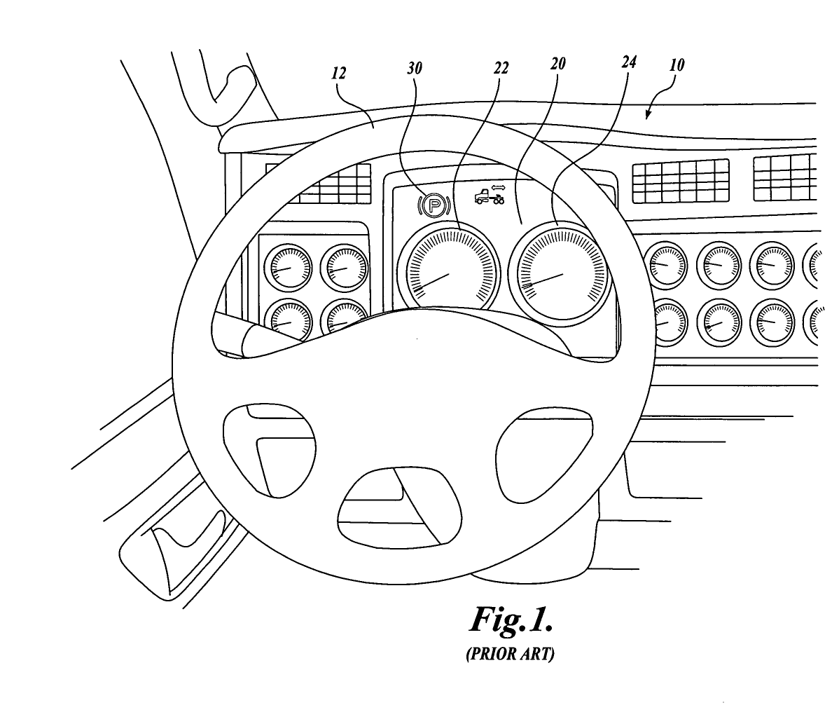

The presently disclosed subject matter relates to a system and method of automatically identifying the telltales included in a telltale warning light system. Referring to FIG. 1, the interior of a vehicle is shown wherein a dashboard 10 is located forward of a steering wheel 12. A plurality of gauges and instruments are disposed within the dashboard 10 so as to be visible to the vehicle operator. In addition, a modular instrument cluster 20 is positioned in the dashboard 10 in front of the steering wheel 12. The instrument cluster 20 includes a tachometer 22 and a speedometer 24. The instrument cluster 20 further includes a plurality of telltales 30 to display information about various vehicle operating conditions to the vehicle operator. While the telltales 30 described herein are included in an instrument cluster 20, it should be understood that the telltales are not limited to embodiments that include instrument clusters located on the dashboard, but can be included on any display panel located at any location on the vehicle.

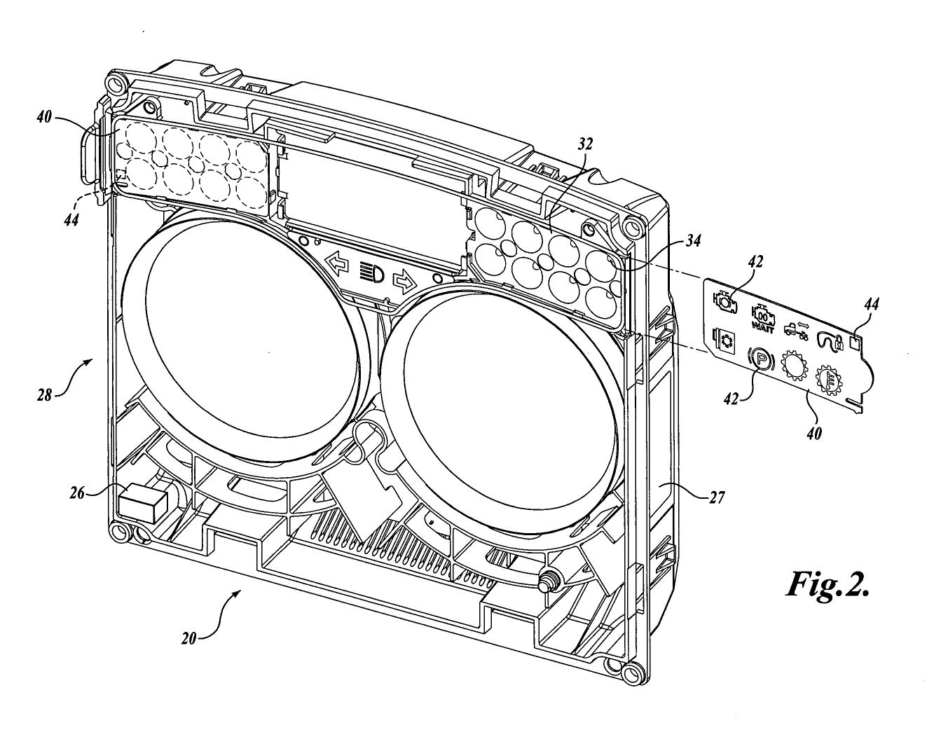

Referring to FIG. 2, one embodiment of an instrument cluster 20 is shown. The components of the instrument cluster 20 are disposed within a housing 27, which is open on one side to define a display side 28 of the instrument cluster. A plurality of telltales 30 is located in each of the upper corners of the instrument cluster 20. Each plurality of telltales 30 comprises a plurality of lighting means 34, an eggcrate assembly 32, and an icon card 40. It should be appreciated that the number and location of telltales can vary for different instrument cluster configurations. For the sake of clarity, a single group of telltales having a common eggcrate assembly 32 and icon card 40 are described herein.

The eggcrate assembly 32 comprises a plurality of interconnected tubes arranged so that the centerlines of the tubes are generally parallel. The eggcrate assembly 32 is disposed within the housing 27 of the instrument cluster 20 and positioned so that the ends of the tubes open to the display side 28 of the instrument cluster 20. A circuit board (not shown) is disposed within the housing 27 behind the eggcrate assembly 32.

A plurality of lighting means 34 are mounted on the circuit board so that each of the lighting means 34 is positioned within one of the tubes of the eggcrate assembly 32. The lighting means 34 can be light emitting diodes (LED), incandescent bulbs, or any other suitable light emitting device. Further, lighting means 34 that produce different colored lights can be used to provide telltales having different colors when illuminated. A plurality of lighting means, each having a different color can be disposed within a single tube of the eggcrate assembly in order to illuminate a particular telltale with a different color light for each of a plurality of operating conditions. For example, a single tube in the eggcrate assembly 32 can contain red, yellow and green lighting means to illuminate a telltale indicating engine temperature. When the engine temperature is within an acceptable range, the green lighting means illuminates the telltale, indicating normal operating conditions. When the engine temperature is approaching an unacceptable threshold, the yellow lighting means illuminates the telltale, warning the vehicle operator of an impending undesirable condition. The red lighting means illuminates the telltale when the engine temperature has exceeded the acceptable threshold, signaling to the operator that corrective action is required.

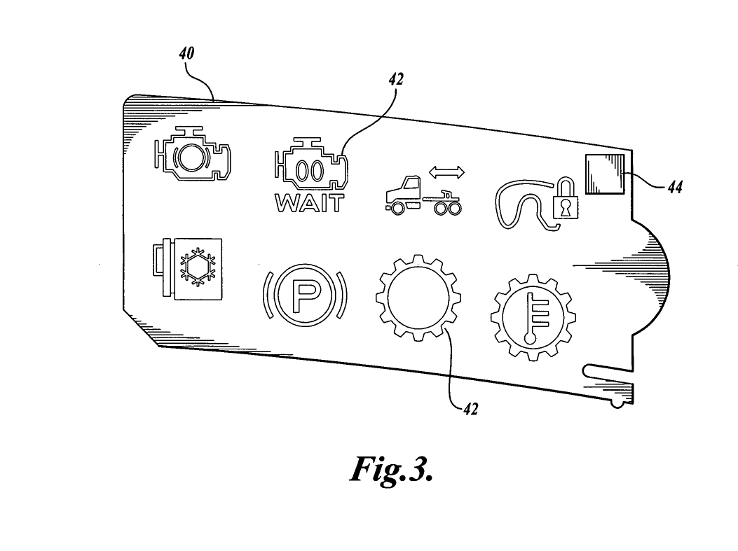

The telltale image is formed by placing a display panel cover over the eggcrate assembly 32 to cover the lighting means 34. In one embodiment, the display panel cover comprises an icon card 40. Referring to FIG. 3, an icon card 40 is formed from a substantially opaque material. A plurality of icons 42 are printed on the card so that each icon is located proximate to an open end of an eggcrate housing tube when the icon card 40 is installed on the instrument cluster 20. Each icon 42 is a translucent image formed on the otherwise opaque icon card 40. As referred to herein, an image is considered translucent if it allows any amount of incident light to be transmitted therethrough, up to and including 100% of the incident light. As a result, when the lighting means 34 disposed within an eggcrate assembly tube emits light, the illuminated icon 42 is visible on the front of the icon card 40.

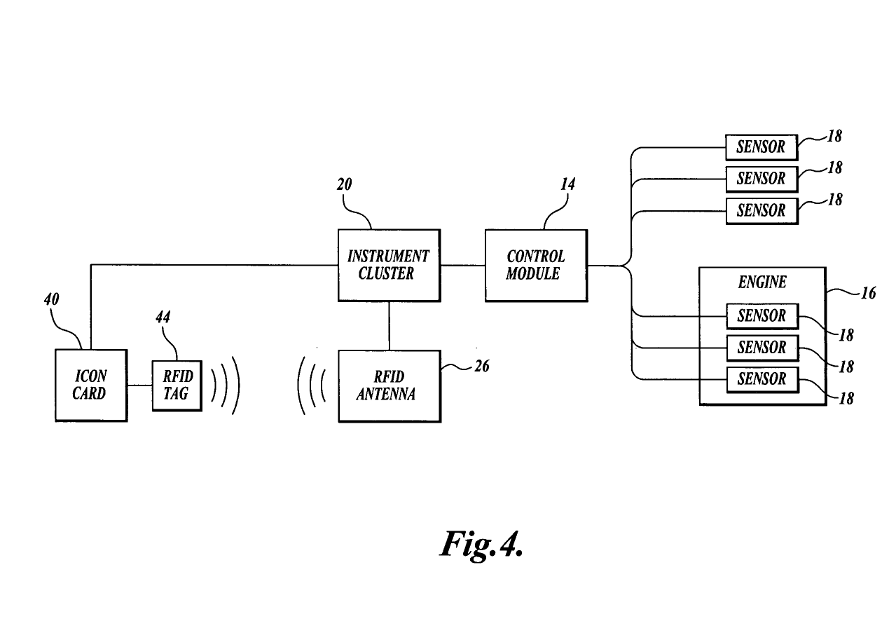

As shown in FIG. 4, the instrument cluster 20 is connected to and controlled by a control module 14. The control module 14 is in turn connected to a plurality of sensors 18 located throughout the vehicle. The sensors 18 sense various parameters and send signals to the control module 14. The control module 14 is programmed to determine the occurrence of predetermined vehicle operating conditions from the received signals. When a condition is determined, the control module 14 sends a control signal to the instrument cluster 20 to activate or deactivate one or more telltales according to the determined condition. In addition to signaling a simple on/off telltale condition, the control module can also instruct the instrument cluster 20 with respect to other telltale characteristics, such as flashing or telltale color.

Because instrument clusters 20 can be configured with different telltales 30 each control module 14 must be programmed to cooperate with the particular telltales 30 present in the installed instrument cluster 20. Currently known control modules 14 are normally programmed when the vehicle is manufactured; however, after an icon card 40 is installed, it is difficult to verify that the control module 14 is properly programmed for the installed icon card 40 without performing a full diagnostic check of the telltales 30. This difficulty arises because the part numbers that identify the icon card configurations are not visible after the icon cards have been installed.

As shown in FIGS. 2 and 3, the presently disclosed icon card 40 includes a signal transmitting device 44 formed or attached thereon. The signal transmitting device 44 is encoded with information regarding the telltale configuration, including the type, location, and operating characteristics of telltale icons 42 present on the icon card 40. A receiver 26 is mounted within the instrument cluster housing 27 to receive the signals transmitted by the signal transmitting device 44. The receiver 26 is in communication with the control module 14 and transmits information regarding the telltale configuration to the control module 14. In response to the information transmitted from the receiver 26, the control module 14 is programmed to operate according to the telltale configuration of the installed icon card 40. That is, the control module 14 is programmed to determine operating conditions to be displayed by the telltales based on signals received by the sensors 18 and to control the operation of the telltales accordingly.

In the illustrated embodiment, the signal transmitting device 44 is a radio frequency identification transponder (RFID tag) and the receiver 26 is an RFID antenna that receives the radio frequencies emitted by the RFID tag. Thus, the signal transmitting device 44 transmits information to the receiver wirelessly, obviating the need for physical contact between the signal transmitting device 44 and the receiver 26. It should be understood that the signal transmitting device 44 can also transmit information wirelessly using methods other than radio frequencies, including infrared light, laser light, visible light, acoustic energy, or other suitable means. Further, while the receiver 26 is illustrated as being disposed within the instrument cluster housing 27, alternate locations that allows the receiver 26 to detect the signal transmitted by the transmitting device 44 can be utilized. In other embodiments, the receiver 26 is located so that it is does not detect the signal from the signal transmitting device 44 when the icon card 40 is installed. Such embodiments include a receiver located on the vehicle remote to the instrument cluster 20 so that the icon card 40 is temporarily positioned proximate to the receiver 26 to “scan” the icon card 40 prior to installation. In another alternate embodiment, the receiver 26 is temporarily connected to the vehicle to scan the icon card 40 during installation and then removed after the scanned information is transmitted to the control module 14. In still another alternate embodiment, the receiver 26 physically contacts the transmitting decive 44 when the icon card 40 is installed, thereby creating a hardwired connection through which telltale information is transmitted.

The presently disclosed automated telltale identification system is suitable for use in a variety of situations. In one exemplary use, the system is used to configure the control module 14 during the vehicle manufacturing process. Many vehicle assembly lines are used to produce vehicles with customizable options or to produce multiple vehicles on the same line. As a result, different vehicles produced on a particular assembly line often have different telltale configurations. Using the presently disclosed telltale identification system, an RFID antenna 26 is installed in the vehicle. One or more icon cards 40, each having an RFID tag 44 corresponding to the telltale icons 42 contained on the icon card 40, are installed on the vehicle. Each vehicle has a bill of materials (BOM), which specifies the parts required to assemble that particular vehicle, including one or more icon cards 40 having telltales according to the vehicle's configuration. Once installed, each RFID tag 44 is in sufficient proximity to the RFID antenna 26 so that the signal transmitted from the RFID tag 44 is received by the RFID antenna 26. The RFID antenna 26 transmits the received signal to the control module 14, which is reprogrammed to receive signals from the vehicle sensors 18 and to control the telltales 30 in accordance with the telltale configuration of each icon card 44. Thus, the control module 14 is automatically programmed according to the information embedded in the installed icon card 40. As a result, potential errors that could result by manually programming the control module are eliminated. Further, elimination of these potential error also eliminates the need to run a diagnostic check to ensure that the control module 14 is programmed to properly operate the telltales 30 present on the vehicle.

While parts are normally delivered to a location on the assembly line where they will be installed, this procedure creates the possibility that incorrect parts will be delivered for a particular vehicle and installed thereon. Thus, it is possible that the incorrect icon cards 40 for a particular vehicle will be delivered and installed on the vehicle. One way to prevent this error from occurring requires that the part number for the icon cards be checked against the BOM for the particular vehicle and/or performing a diagnostic check on the instrument cluster 20 after the icon card has been installed. Both options add time and cost to the manufacturing process.

In another use of the presently disclosed telltale identification system, a device for producing icon cards 40 is located proximate to the location on the assembly line where the icon cards 40 are installed. When a vehicle is in a position to have the icon cards installed, the device for producing icon cards determines the telltales required by that vehicle based on the vehicle's BOM. The device then produces the appropriate icon cards for that particular vehicle, complete with the correct telltale icons and a corresponding RFID tag. By producing the icon cards 40 at the point of installation and in accordance with just-in-time manufacturing principles, the potential for errors due to misdelivered or misidentified parts is greatly reduced.

Yet another use of the presently disclosed telltale identification system allows for the control module to be easily reprogrammed when the telltales are changed from one configuration to another. Vehicle manufacturers often sell a base model to a customer that the customer then has configured to his or her specifications by a third party. For example, a customer may purchase from a manufacturer an incomplete chassis, which the customer then takes to a third party manufacturer to be converted into, for example, a dump truck, a cement mixer, or whatever configuration the customer requires. Because the telltale configuration often depends on the vehicle configuration, it may be necessary to install non-standard icon cards 40 for non-standard configurations.

Using the present telltale identification system, a third party can inform the vehicle manufacturer of the specific telltale requirements for a modified vehicle, and the manufacturer can supply custom icon cards 40 according to the third party's needs. Because the information about the telltale configuration is contained in an RFID tag 44 included on the icon card 40, the third party only needs to install the icon card 40 on the vehicle. Once the icon card 40 is installed, the RFID tag 44 transmits information about the telltale configuration to the RFID antenna 26, which sends a signal to that causes the control module 14 to be programmed or reprogrammed. Alternatively, the third party has a device to manufacture icon cards 40 with an RFID tag 44 and manufactures the icon cards on-site in accordance with the vehicle's telltale configuration.

The embodiments of the invention in which an exclusive property or privilege is claimed are defined as follows:

1. A vehicle display device, comprising:
(a) a display panel having a selectively operable light emitting device;
(b) a display panel cover coupled to the display panel, the display panel cover having a translucent indicium corresponding to the selectively operable light emitting device;
(c) a control module;
(d) a signal transmitting device provided on the display panel cover for sending a signal corresponding to the indicium on the display panel cover; and
(e) a signal receiving device capable of receiving a signal transmitted by the signal transmitting device and sending the signal to the control module,
wherein the control module is adapted to selectively operate the light emitting device according to the signal transmitted by the signal transmitting device.

2. The vehicle display device of claim 1, wherein the signal transmitting device is capable of sending signals wirelessly.

3. The vehicle display device of claim 2, wherein the signal transmitting device is an RFID tag.

4. The vehicle display device of claim 2 wherein the signal transmitting device is capable of transmitting one of a laser light, a visible light, and acoustic energy.

5. The vehicle display device of claim 1, wherein the control module is adapted to selectively operate the light emitting device in response to detected parameters, said detected parameters being determined according to the signal received by the signal receiving device.

6. The vehicle display device of claim 1, wherein software is installed in the control module, the software being programmable according to the signal received by the signal receiving device.

7. The vehicle display device of claim 1, wherein portions of the display cover panel surrounding the translucent indicium are opaque.

8. The vehicle display device of claim 1, wherein the vehicle display cover comprises at least one flat icon card.

9. The vehicle display device of claim 8, wherein the at least one flat icon card is removably coupled to the vehicle display device.

10. The vehicle display device of claim 1, wherein the light emitting means comprises at least one light emitting diode.

11. The vehicle display device of claim 1, wherein the at least one light emitting diode comprises a first light emitting diode for emitting light of a first color and a second light emitting diode for emitting light of a second color.

12. The vehicle display device of claim 1, wherein the light emitting means comprises at least one incandescent light bulb.

13. The vehicle display device of claim 1, wherein the signal transmitting device is disposed within the vehicle display panel.

14. A method for programming a microprocessor to selectively operate a light emitting device on a vehicle display device, said vehicle display device having a display panel and a display panel cover couplable to the display panel, the method comprising:
(a) transmitting a signal from a signal transmitting device provided on the display panel cover;
(b) receiving the signal transmitted from the signal transmitting device with a signal receiving device;
(c) sending the signal received by the signal receiving device to the microprocessor; and
(d) programming the microprocessor to selectively operate the light emitting device in accordance with the signal received by the signal receiving device.

15. The method of claim 14, further comprising coupling the display panel cover to the display panel.

16. The method of claim 14, further comprising decoupling a first display panel cover from the display panel and coupling a second display panel cover.

17. A method of installing a display cover for a selectively illuminable vehicle display having at least one selectively operable light emitting device, the method comprising:
(a) providing a display cover, the display cover having at least one translucent indicium corresponding to the at least one selectively operable light emitting device and a transmitter, said transmitter being adapted to transmit a signal to identify the at least one translucent indicium; and
(b) attaching the display cover to the selectively illuminable vehicle display so that the at least one translucent indicium is illuminated when the selectively operable light emitting device emits light,
wherein a receiver for receiving a signal transmitted from the transmitter is adapted to send the signal to a control module, the control module being adapted to selectively operate the light emitting device according to the signal.

18. A display panel cover for a vehicle display device, the vehicle display device having a selectively operable light emitting device and a signal receiving device, the display panel cover comprising:
(a) at least one translucent indicium corresponding to the selectively operable light emitting device, and
(b) a signal transmitting device provided on the display panel cover for sending a signal to the signal receiving device, the signal corresponding to the at least one indicium on the display panel cover.

19. The display panel cover of claim 18, wherein the signal transmitting device is capable of sending signals wirelessly.

20. The display panel cover of claim 19, wherein the signal transmitting device is an RFID tag.

21. The display panel cover of claim 19, wherein the signal transmitting device is capable of transmitting one of a laser light, a visible light, and acoustic energy.

22. The display panel cover of claim 18, wherein portions of the display panel cover surrounding the translucent indicium are opaque.

23. The display panel cover of claim 18, wherein the vehicle display panel cover is formed as a flat icon card.

24. The display panel cover of claim 18, wherein the vehicle display panel cover is removably coupled to the vehicle display device.
